(19) United States
(12) Patent Application Publication
(10) Pub. No.: US 2026/0116828 A1
(43) Pub. Date: Apr. 30, 2026

(54) SYNTHESIS OF DIAMOND-BORON CARBIDE (B4C) CERAMIC MATERIALS

(71) Applicant: Diamond Innovations, Inc., Worthington, OH (US)

(72) Inventor: Emil Stoyanov, Livermore, CA (US)

(21) Appl. No.: 19/359,798

(22) Filed: Oct. 16, 2025

Related U.S. Application Data
(60) Provisional application No. 63/714,400, filed on Oct. 31, 2024.

(51) Int. Cl. C04B 35/52; C04B 35/626; C04B 35/645

(52) U.S. Cl. CPC C04B 35/52; C04B 35/62655; C04B 35/645; C04B 2235/3821; C04B 2235/427; C04B 2235/549; C04B 2235/658; C04B 2235/77

(57) ABSTRACT

Provided is a novel super-hard reinforced boron carbide (B₄C)-diamond composite material including diamond particles present in a weight of from about 91 weight percent (wt. %) to about 95 wt. % based on a total weight of the composite and B₄C particles present in a weight of from about 5 wt. % to about 9 wt. % based on a total weight of the composite. The super-hard reinforced B₄C-diamond composite is essentially graphite-free and pore-free. Further provided are associated methods for preparing such reinforced B₄C-diamond composite materials, and cutting tools incorporating the reinforced B₄C-diamond composite materials.

### FIELD OF THE DISCLOSURE

The present disclosure relates to super-hard reinforced boron carbide (B₄C)-diamond composite materials, to associated methods for preparing such reinforced (B₄C)-diamond composite materials, and to cutting tools incorporating the super-hard reinforced B₄C-diamond composite materials.

### BACKGROUND

Boron carbide having the molecular formula B₄C is known to be a ceramic material having a relatively low density, a good hardness and fracture toughness, and a high strength. B₄C is typically used as a wear-resistant and an abrasion-resistant material, in for example body armors, and as a neutron absorber in nuclear reactors. Compared to for example superabrasive materials like for instance diamond and cubic boron nitride (cBN), what makes B₄C a considerably attractive material is that it is fairly easy to prepare and at relatively low costs. Growing body of evidence suggests that B₄C has been widely used in fracture toughness-demanding operations involving a significant abrasive wear, like for example grinding, cutting, drilling, milling, mining, and general machining operations.

B₄C is chemically inert even to most acids, and has a high neutron absorbing cross-section. B₄C may be hot-pressed into useful shapes for components with outstanding resistance to physical abrasion and wear and tear. B₄C is characterized by demonstrating a high elastic modulus (e.g., >435 GPa), a high melting point (e.g., 2450° C.), and a high Hugoniot elastic limit (e.g., >18 GPa). B₄C has a hardness of about 30 GPa, which is exceeded only by cubic boron nitride (cBN) being about 48 GPa, and by diamond being about 115 GPa. Unlike diamond, B₄C exhibits a low thermal conductivity, however nonetheless, demonstrates a high thermal stability. cBN equally exhibits a high thermal stability, but is only about half as hard as diamond.

Because B₄C is characterized by a combination of such favorable aforementioned physical, chemical and mechanical properties, B₄C has been widely viewed as a potential candidate for many industrial, military and energy applications. B₄C is used as a grinding medium for hard materials in wear-resistant sand-blasting nozzles, in nuclear reactors and high-temperature thermoelectric conversion units, and as previously mentioned, qualifies as a lightweight ceramic armor material. Notwithstanding that intensified research efforts have been channeled towards development of B₄C for a multitude of industrial applications as described above, it would be desirable to develop super-hard reinforced composites combining the physical, mechanical, and chemical attributes of B₄C together with those of diamond.

Thus, there is a need for novel super-hard reinforced B₄C-diamond composite materials with favorable material qualities, and associated methods for preparing such super-hard reinforced B₄C-diamond composite materials.

### SUMMARY

Provided is a super-hard boron reinforced carbide (B₄C)-diamond composite including diamond particles present in a weight of from about 91 weight percent (wt. %) to about 95 wt. % based on a total weight of the composite. The super-hard reinforced B₄C-diamond composite further includes B₄C particles present in a weight of from about 5 wt. % to about 9 wt. % based on a total weight of the composite. The super-hard reinforced B₄C-diamond composite is essentially graphite-free and pore-free.

Optionally, the diamond particles include a diamond material selected from the group consisting of monocrystalline diamond and polycrystalline diamond, and have a D50 particle size in a range of from about 21 microns to about 50 microns.

Optionally, the B₄C-diamond composite has a density in a range of from about 3.32 g/cm³ to about 3.36 g/cm³.

Further provided is a method of forming the super-hard B₄C-diamond composite including preparing a batch of powdered materials having a diamond powder in a weight of from about 91 weight percent (wt. %) to about 95 wt. % based on a total weight of the batch of powdered materials and an amorphous boron powder in a weight of from about 5 wt. % to about 9 wt. % based on a total weight of the batch of powdered materials. The batch of powdered materials is next mixed to form a powder blend. The formed powder blend is then dried by either vacuum drying, air drying, freeze drying, furnace drying, or spray drying, and next loaded into one or more refractory metal containers or refractory cups. Finally, the dried powder blend is sintered in a solid-state at high pressure high temperature (HPHT) conditions to form the super-hard reinforced B₄C-diamond composite. The super-hard reinforced B₄C-diamond composite is essentially graphite-free and pore-free.

Optionally, the HPHT conditions to form the super-hard B₄C-diamond composite include using an internal cell pressure in a range of from about 5 GPa to about 9 GPa, from about 5.8 GPa to about 7.4 GPa, from about 7.2 GPa to about 7.4 GPa, at about 5.8 GPa, at about 7.2 GPa, or at about 7.4 GPa, and an internal cell temperature in a range of from about 1200° C. to about 1700° C.

Optionally, the mixing is performed with one or more solvents including ethanol, methanol, isopropanol, butanol, cyclohexanol, acetone, hexane, heptane, toluene, water, or any combination thereof, as a slurry mix of the powder blend.

Optionally, trace impurities are present in the prepared super-hard B₄C-diamond composite material, which are sweeps from the applied tantalum cup, and which trace impurities include one or more of tantalum (Ta), niobium (Nb), or tantalum boride (TaB₂).

Further provided are cutting tools incorporating the reinforced B₄C-diamond composite materials.

Other systems, features and advantages will be, or will become, apparent to one with skill in the art upon examination of the following figures and detailed description. It is intended that all such additional systems, features and advantages be included within this description, be within the scope of the present disclosure, and be protected by the following claims. Nothing in this section should be taken as a limitation on those claims. Further aspects and advantages are discussed below in conjunction with the embodiments of the disclosure. It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the subject matter and are incorporated in and constitute a part of this specification, illustrate implementations of the subject matter and together with the description serve to explain the principles of the disclosure.

FIG. 1A shows an X-ray diffraction (XRD) spectroscopy of a boron carbide (B₄C)-diamond composite sample sintered at 1200° C. for 30 minutes in a cubic press and at a 5.8 GPa internal cell pressure in accordance with the present subject matter. To prepare the B₄C-diamond composite either a 5 wt. % amorphous boron powder and a 95 wt. % diamond powder were used (i.e., upper brown chart), or a 10 wt. % amorphous boron powder and 90 wt. % diamond powder were used (i.e., lower red chart).

FIG. 1B shows an X-ray diffraction (XRD) spectroscopy of a boron carbide (B₄C)-diamond composite sample sintered at a temperature of 1700° C. for 20 minutes in a cubic press and at a 7.2-7.4 GPa internal cell pressure in accordance with the present subject matter. To prepare the B₄C-diamond composite, a 10 wt. % amorphous boron powder and a 90 wt. % diamond powder were used.

FIG. 2 shows a 1000× magnification of a scanning electron microscope (SEM) of a boron carbide (B₄C)-diamond composite sample sintered at a temperature of 1200° C. for 30 minutes in a cubic press at a 5.8 GPa internal cell pressure in accordance with the present subject matter. To prepare the B₄C-diamond composite, a 10 wt. % amorphous boron powder and a 90 wt. % diamond powder were used.

FIG. 3A shows a 1000× magnification of a scanning electron microscope (SEM) of a boron carbide (B₄C)-diamond composite sample sintered at a temperature of 1700° C. for 20 minutes in a cubic press at a 7.2-7.4 GPa internal cell pressure in accordance with the present subject matter. To prepare the B₄C-diamond composite, a 10 wt. % amorphous boron powder and a 90 wt. % diamond powder were used.

FIG. 3B shows an energy-dispersive X-ray spectroscopy (EDS) spectrum collected from region marked with #14 in FIG. 3A of the boron carbide (B₄C)-diamond composite sample sintered at a temperature of 1700° C. for 20 minutes in a cubic press at a 7.2-7.4 GPa internal cell pressure in accordance with the present subject matter. To prepare the B₄C-diamond composite, a 10 wt. % amorphous boron powder and a 90 wt. % diamond powder were used.

FIG. 3C shows an Energy-dispersive X-ray spectroscopy (EDS) spectrum collected from region marked with #13 in FIG. 3A of the boron carbide (B₄C)-diamond composite sample sintered at a temperature of 1700° C. for 20 minutes in a cubic press at a 7.2-7.4 GPa internal cell pressure in accordance with the present subject matter. To prepare the B₄C-diamond composite, a 10 wt. % amorphous boron powder and a 90 wt. % diamond powder were used.

FIG. 4 shows a flow diagram demonstrating the individual process steps for preparing a graphite-free and a pore-free super-hard reinforced boron carbide B₄C-diamond composite in accordance with the present subject matter.

### DETAILED DESCRIPTION

Unless defined otherwise all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

The following definitions set forth the parameters of the described subject matter.

As used herein, the term “about” is meant to mean plus or minus 5% of the numerical value of the number with which it is being used in the claims and herein this disclosure. Thus, “about” may be used to provide flexibility to a numerical range endpoint, in which, a given value may be “above” or “below” the given value. As such, for example a value of 50% may be intended to encompass a range, which may be defined by for example ranges like 47.5%-52.25%, 47.5%-52.5%, 47.75%-50%, 50%-52.5%, 48%-48.5%, 48%-48.75%, 48%-49%, 48%-49.5%, 48%-49.75%, 48%-50%, 48%-50.25%, 48%-50.5%, 48%-50.75%, 48%-51%, 48%-51.5%, 48%-51.75%, 48%-52%, 48%-52.25%, 48%-52.5%, 48.25%-48.5%, 48.25%-48.75%, 48.25%-49%, 48.25%-49.5%, 48.25%-49.75%, 48.25%-50%, 48.25%-50.25%, 48.25%-50.5%, 48.25%-50.75%, 48.25%-51%, 48.25%-51.25%, 48.25%-51.5%, 48.25%-51.75%, 48.25%-52%, 48.25%-52.25%, 48.25%-52.5%, 48.5%-48.75%, 48.5%-49%, 48.5%-49.5%, 48.5%-49.75%, 48.5%-50%, 48.5%-50.25%, 48.5%-50.5%, 48.5%-50.75%, 48.5%-51%, 48.5%-51.25%, 48.5%-51.5%, 48.5%-51.75%, 48.5%-52%, 48.5%-52.25%, 48.5%-52.5%, 49%-49.25%, 49%-49.5%, 49%-49.75%, 49%-50%, 49%-50.25%, 49%-50.5%, 49%-50.75%, 49%-51%, 49%-51.25%, 49%-51.5%, 49%-51.75%, 49%-52%, 49%-52.25%, 49%-52.5% 49.5%-49.75%, 49.5%-50%, 49.5%-50.25%, 49.5%-50.5%, 49.5%-50.75%, 49.5%-51%, 49.5%-51.5%, 49.5%-51.75%, 49.5%-52%, 49.5%-52.25%, 49.5%-52.5%, 49.75%-50%, 49.75%-50.25%, 49.75%-50.5%, 49.75%-50.75%, 49.75%-51%, 49.75%-51.25%, 49.75%-51.5%, 49.75%-51.75%, 49.75%-52%, 49.75%-52.25%, 49.75%-52.5%, 50%-50.25%, 50%-50.5%, 50%-50.75%, 50%-51%, 50%-51.25%, 50%-51.5%, 50%-52%, 50%-52.25%, 50%-52.5% etc. As used herein this disclosure, the term “predominantly” is meant to encompass at least 95% of a given entity.

As used herein, the terms “ambient condition” and “room temperature” refer to 25° C., 298.15 K at a pressure of 101.325 kPa.

As used herein, the term “D50” refers to a particle size corresponding to 50% of the volume of the sampled particles being smaller than and 50% of the volume of the sampled particles being greater than the recited D50 value. Similarly, the term “D90” refers to a particle size corresponding to 90% of the volume of the sampled particles being smaller than and 10% of the volume of the sampled particles being greater than the recited D90 value. The term “D10” refers to a particle size corresponding to 10% of the volume of the sampled particles being smaller than and 90% of the volume of the sampled particles being greater than the recited D10 value. A width of the particle size distribution can be calculated by determining the span, which is defined by the equation (D90−D10)/D50. The span gives an indication of how far the 10 percent and the 90 percent points are apart normalized with the midpoint.

As used herein, the term “diamond particle” refers to a discrete body or discrete bodies made of diamond. As used herein, the term “diamond particle” is also considered a diamond crystal or a diamond grain, and is therefore used interchangeably with a diamond crystal or a diamond grain.

Wherever used throughout the disclosure, the term “generally” has the meaning of “approximately”, “typically” or “closely” or “within the vicinity or range of”.

As used herein this disclosure, the term “high pressure high temperature (HPHT) sintering” refers to a process, where heating at an internal cell temperature typically ranging from about 1200° C. to about 2000° C. and at a high internal cell pressure generally spanning from about 4 gigapascal (GPa) to about 9 GPa is conducted to minimize the surface of a super-hard reinforced B₄C-diamond-based particulate composite (i.e., a compact). This is associated with generation of bonds between neighboring amorphous boron particles and diamond particles, and shrinkage of the thus formed and aggregated B₄C-diamond particulate composite. Compacting and forming a dense bulk mass is performed by heating the amorphous boron particles and the diamond particles under the aforementioned high temperatures and pressures. The atoms in the amorphous boron particles and the diamond particles diffuse across their boundaries, thereby fusing the amorphous boron particles and the diamond particles together, thereby creating one solid dense bulk piece of the B₄C-diamond composite with an increased density. Although a number of HPHT apparatuses are generally known to one having ordinary skill in the art, the two most common apparatuses for performing HPHT sintering are the cubic presses and belt presses.

As used herein, the term “monocrystalline diamond” refers to a diamond having an overall flat structural surface that is formed either by a high-pressure high-temperature (HPHT) consolidation operation or to a diamond that is naturally formed. Fracture of the monocrystalline diamond proceeds along atomic cleavage-planes. A monocrystalline diamond particle breaks relatively easily at the cleavage-planes.

As used herein, the term “polycrystalline diamond” refers to a diamond formed by explosion-synthesis resulting in a polycrystalline particle-structure. Each polycrystalline diamond particle may include large numbers of microcrystallites less than about 100 angstroms in size. Polycrystalline diamond particles do not have cleavage planes.

As used herein, the term “porosity” is defined by the degree, whereby a given material has a hole, a void, or a space.

As used herein, the term “substantially” refers to the complete or nearly complete extent or degree of an action, characteristic, property, state, structure, item, or result.

As used herein this disclosure, the terms “super-hard composite”, “super-hard reinforced composite”, “super-hard compact”, or “super-hard reinforced compact” are used interchangeably, and refer to a superabrasive material demonstrating superior hardness, abrasion resistance and wear resistance as found in the following materials, but not limited to e.g., reinforced B₄C-diamond composites, SiC-diamond composites, SiC-TiN-diamond composites, SiC-TiCN-diamond composites, SiC-TiN-TiCN-diamond composites, crystal diamond, polycrystalline diamond (PCD), monocrystalline diamond, thermally stable polycrystalline diamond, chemical vapor deposition (CVD) diamond, metal matrix diamond composites, ceramic matrix diamond composites, nanodiamond, cubic boron nitride (cBN), polycrystalline cubic boron nitride (PcBN), or any combinations thereof. As used herein this disclosure, the term “abrasive”, refers to any material used to wear away softer material than the abrasive itself.

As used herein, the term, “trace impurities” refer to impurities including at a bare minimum any one of tantalum (Ta), niobium (Nb), tantalum boride (TaB₂), iron (Fe), titanium (Ti), ruthenium (Ru), zirconium (Zr), aluminum (Al), or yttrium (Y), or any combinations of the foregoing. The impurity level is a level, such as e.g., less than about 0.1 wt. %, less than about 0.09 wt. %, less than about 0.08 wt. %, less than about 0.07 wt. %, less than about 0.06 wt. %, less than about 0.05 wt. %, less than about 0.04 wt. %, less than about 0.03 wt. %, less than about 0.02 wt. %, less than about 0.01 wt. %, or in an amount of from about 0.01 wt. % to about 0.1 wt. %, in an amount of from about 0.02 wt. % to about 0.1 wt. %, in an amount of from about 0.03 wt. % to about 0.1 wt. %, in an amount of from about 0.04 wt. % to about 0.1 wt. %, in an amount of from about 0.05 wt. % to about 0.1 wt. %, in an amount of from about 0.06 wt. % to about 0.1 wt. %, in an amount of from about 0.07 wt. % to about 0.1 wt. %, in an amount of from about 0.08 wt. % to about 0.1, from about 0.09 wt. % to about 0.1 wt. %, in an amount of from about 0.02 wt. % to about 0.03 wt. %, in an amount of from about 0.02 wt. % to about 0.04 wt. %, in an amount of from about 0.02 wt. % to about 0.05 wt. %, in an amount of from about 0.02 wt. % to about 0.06 wt. %, in an amount of from about 0.02 wt. % to about 0.07 wt. %, in an amount of from about 0.02 wt. % to about 0.08 wt. %, in an amount of from about 0.02 wt. % to about 0.09 wt. %, in an amount of from about 0.03 wt. % to about 0.06 wt. %, in an amount of from about 0.04 wt. % to about 0.06 wt. %, in an amount of from about 0.05 wt. % to about 0.06 wt. %, in an amount of from about 0.05 wt. % to about 0.07 wt. %, in an amount of from about 0.05 wt. % to about 0.08 wt. %, in an amount of from about 0.05 wt. % to about 0.09 wt. %, in an amount of from about 0.06 wt. % to about 0.09 wt. %, in an amount of from about 0.07 wt. % to about 0.09 wt. %, or in an amount of from about 0.08 wt. % to about 0.09 wt. %.

As used herein this disclosure, “wt. %” refers to either a given weight percent (%) based on the total weight of the boron carbide (B₄C)-diamond composite or a total weight of a batch of powdered materials.

### Super-Hard Reinforced Boron Carbide (B₄C)-Diamond Composites

The current disclosure relates to novel lightweight graphite-free and pore-free, thermally stable, and impact-resistant super-hard reinforced boron carbide (B₄C)-diamond composite materials with stellar material characteristics, and to associated methods for preparing such novel B₄C-diamond composites. The B₄C-diamond composites disclosed herein are strong enough to withstand centerless grinding operation and a surface grinding of both ends of the produced cylinder. One of the essential features of the subject matter is the in-situ formation of ultra-hard phases (e.g., B₄C) completely without the need for conducting a liquid phase sintering operation. Solid state sintering occurs when the powder composite is typically densified entirely in a solid state at the conducted sintering temperature, while liquid phase sintering generally occurs, when solely a liquid phase is present in the powder composite during sintering at the operated sintering temperature. Another essential feature is the pressing of the diamond under conditions, where it is thermodynamically unstable, and advantageously utilizing the diamond-graphite back-conversion reaction used as a free source of activated carbon for the formation of the B₄C super-hard phases in the prepared composite. Without being bound by a particular theory, the use of amorphous boron with a wide range of particle size distribution (PSD) is potentially the reason for the successful formation of such ultra-hard B₄C phases. Crystalline boron, on the other hand, is known to be a very hard and stable material typically with a melting temperature well above 2000° C. Again, without being bound by a particular theory, using boron in the amorphous state may potentially lower the kinetic barriers associated with crystalline materials used in chemical processes, and may enable solid-state reactions to occur under more approachable conditions.

The reinforced B₄C-diamond composite may typically include diamond particles constituted of diamond selected from the group consisting of monocrystalline diamond and polycrystalline diamond, being present in a weight of from about 91 weight percent (wt. %) to about 95 wt. % based on a total weight of the reinforced B₄C-diamond composite. In some examples, the diamond particles are present in a weight of from about 92 wt. % to about 95 wt. % based on a total weight of the reinforced B₄C-diamond composite. In other examples, the diamond particles are present in a weight of from about 93 wt. % to about 95 wt. % based on a total weight of the reinforced B₄C-diamond composite. In still other examples, the diamond particles are present in a weight of from about 94 wt. % to about 95 wt. % based on a total weight of the reinforced B₄C-diamond composite. In yet other examples, the diamond particles are present in a weight of from about 91 wt. % to about 92 wt. % based on a total weight of the reinforced B₄C-diamond composite. In even other examples, the diamond particles are present in a weight of from about 92 wt. % to about 93 wt. % based on a total weight of the reinforced B₄C-diamond composite. In even further other examples, the diamond particles are present in a weight of from about 91 wt. % to about 93 wt. %, from about 91 wt. % to about 94 wt. %, or from about 93 wt. % to about 94 wt. % based on a total weight of the reinforced B₄C-diamond composite.

The reinforced B₄C-diamond composite including diamond particles, having a diamond material selected from the group consisting of monocrystalline diamond and polycrystalline diamond, may generally exhibit a D50 particle size spanning a range of from about 21 microns to about 50 microns. In some examples, the D50 particle size of the diamond particles spans a range of from about 25 microns to about 50 microns. In other examples, the D50 particle size of the diamond particles spans a range of from about 30 microns to about 50 microns. In yet other examples, the D50 particle size of the diamond particles spans a range of from about 35 microns to about 50 microns. In still other examples, the D50 particle size of the diamond particles spans a range of from about 40 microns to about 50 microns. In even other examples, the D50 particle size of the diamond particles spans a range of from about 45 microns to about 50 microns.

The D50 particle size of the monocrystalline and the polycrystalline diamond particles may also span a range of from about 21 microns to about 25 microns, from about 25 microns to about 30 microns, from about 30 microns to about 35 microns, from about 21 microns to about 27 microns, from about 21 microns to about 30 microns, from about 21 microns to about 32 microns, from about 21 microns to about 35 microns, from about 21 microns to about 37 microns, from about 21 microns to about 40 microns, from about 21 microns to about 42 microns, from about 21 microns to about 45 microns, from about 21 microns to about 47 microns, from about 35 microns to about 37 microns, from about 35 microns to about 40 microns, from about 35 microns to about 42 microns, from about 35 microns to about 45 microns, from about 35 microns to about 47 microns, from about 37 microns to about 40 microns, from about 37 microns to about 42 microns, from about 37 microns to about 45 microns, from about 37 microns to about 47 microns, from about 37 microns to about 50 microns, from about 40 microns to about 42 microns, from about 40 microns to about 45 microns, from about 40 microns to about 47 microns, from about 42 microns to about 45 microns, from about 42 microns to about 47 microns, from about 45 microns to about 47 microns, or from about 42 microns to about 50 microns.

For determining a specific diamond particle size, one having ordinary skill in the art may typically employ either dynamic digital image analysis (DIA), static laser light scattering (SLS) also known as laser diffraction, or visual measurement by electron microscopy, a technique known as image analysis and light obscuration. Each method covers a characteristic size range, within which, measurement is possible. These ranges partly overlap. However, the results for measuring the same sample may vary all depending on the particular method that is used. A skilled artisan who is desirous of determining particle size distributions would readily know how each mentioned method is commonly performed and practiced. Thus, the reader is directed to for example, (i) “Comparison of Methods. Dynamic Digital Image Analysis, Laser Diffraction, Sieve Analysis”, Retsch Technology and (ii) the scientific publication by Kelly et al., “Graphical comparison of image analysis and laser diffraction particle size analysis data obtained from the measurements of spherical particle systems”, AAPS PharmSciTech. 2006 Aug. 18; Vol. 7(3):69, to further gain insight into each procedure and methodology.

The reinforced B₄C-diamond composite may generally include B₄C particles being present in a weight of from about 5 weight percent (wt. %) to about 9 wt. % based on a total weight of the reinforced B₄C-diamond composite. In some examples, the B₄C particles are present in a weight of from about 6 wt. % to about 9 wt. % based on a total weight of the reinforced B₄C-diamond composite. In other examples, the B₄C particles are present in a weight of from about 7 wt. % to about 9 wt. % based on a total weight of the reinforced B₄C-diamond composite. In still other examples, the B₄C particles are present in a weight of from about 8 wt. % to about 9 wt. % based on a total weight of the reinforced B₄C-diamond composite.

The B₄C particles in the reinforced B₄C-diamond composite may also be present in a weight of from about 5 wt. % to about 6 wt. %, from about 5 wt. % to about 7 wt. %, or from about 5 wt. % to about 8 wt. %, from about 6 wt. % to about 7 wt. %, from about 6 wt. % to about 8 wt. %, or from about 7 wt. % to about 8 wt. %, based on a total weight of the reinforced B₄C-diamond composite.

The B₄C-diamond composite may typically have a density in a range of from about 3.32 g/cm³ to about 3.36 g/cm³. In some examples, the B₄C-diamond composite has a density in a range of from about 3.33 g/cm³ to about 3.36 g/cm³. In other examples, the B₄C-diamond composite has a density in a range of from about 3.34 g/cm³ to about 3.36 g/cm³. In still other examples, the B₄C-diamond composite has a density in a range of from about 3.35 g/cm³ to about 3.36 g/cm³. In yet examples, the B₄C-diamond composite has a density in a range of from about 3.32 g/cm³ to about 3.34 g/cm³. In even other examples, the B₄C-diamond composite has a density in a range of from about 3.32 g/cm³ to about 3.35 g/cm³. In still other examples, the B₄C-diamond composite has a density in a range of from about 3.33 g/cm³ to about 3.35 g/cm³ or has a density in a range of from about 3.34 g/cm³ to about 3.35 g/cm³.

### Methods for Preparing Super-Hard Reinforced Boron Carbide (B₄C)-Diamond Composites

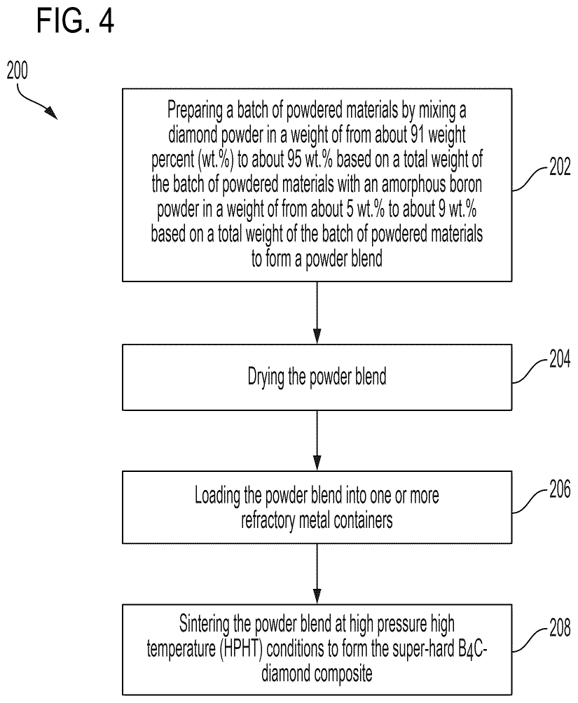

Turning now the attention of the reader to FIG. 4, this figure shows a flow diagram 200 demonstrating the individual process steps for preparing a graphite-free and pore-free, super-hard reinforced B₄C-diamond composite in accordance with the present subject matter.

The process 200, for example, includes preparing a batch of powdered materials by mixing a diamond powder in a weight of from about 91 weight percent (wt. %) to about 95 wt. % based on a total weight of the batch of powdered materials with an amorphous boron powder in a weight of from about 5 wt. % to about 9 wt. % based on a total weight of the batch of powdered materials to form a slurry mix of a powder blend in step 202. Enough amorphous boron binder needs to be present in order to react with, and to bond with the diamond powder, so as to form a graphite-free and a pore-free B₄C-diamond composite material. Thus, the starting material is a blend of the diamond powder and the amorphous boron powder, and the diamond powder exhibits a broad range of particle size distribution (PSD) to improve the packing density with the amorphous boron. The amorphous boron powder equally demonstrates a wide range of PSD to improve the packing density of the formed slurry mix of the diamond-amorphous boron powder blend.

As it would be apparent to a skilled artisan, to form the slurry mix of the diamond powder and the amorphous boron powder blend, first diamond feeds are typically prepared by dissolving a diamond powder in a proper slurry forming liquid or solvent, which may ideally be water, an alcohol, such as e.g. the following, but not limited to ethanol, methanol, isopropanol, butanol, cyclohexanol, an organic solvent in the likes of for example hexane, heptane, acetone or toluene, a water: alcohol mixture, an alcohol: alcohol mixture, a solvent: solvent mixture, an alcohol: solvent mixture, a water: solvent mixture, or any such combinations thereof. The properties of the slurry formed composed of the mix of the diamond powder and the amorphous boron powder are dependent on among other things the amount of the liquid that is added. Because the drying of the slurry mix of the diamond powder and the amorphous boron powder blend requires energy, the amount of the used liquid should preferably be minimized to optimally keep costs down. However, enough liquid needs to be added to obtain an easily pumpable slurry mix of the diamond powder and the amorphous boron powder blend and to avoid clogging of the mixing system. The amorphous boron powder may equally well be dissolved in the same liquids, alcohols, solvents, or mixture thereof as described above for the diamond powder to form a solution of the amorphous boron powder. Next, the formed diamond feeds are mixed with the prepared solution constituted of the amorphous boron on typically a LabRam 2 mixer to form the pumpable slurry mix of the powder blend constituted of the diamond and the amorphous boron in step 202.

The process 200 next includes a drying operation in step 204. The slurry mix of the formed powder blend of the diamond and the amorphous boron can thereafter be dried using any conventional techniques such as for example vacuum drying, air drying, freeze drying, furnace drying, or spray drying to substantially remove by evaporating the liquid from the slurry mix. In the case of for instance spray-drying, the slurry mix of the formed powder blend of the diamond and the amorphous boron may be atomized through an appropriate nozzle in a conventional drying tower by forming sprays, where the atomized small discrete droplets are instantaneously dried by a horizontal inflow of a stream of hot gas into the drying tower, for instance in a stream of hot nitrogen, argon, or air. As used herein, “atomization” refers to a process, where a bulk liquid feed (i.e., milling liquid forming the pumpable slurry mix of the powder blend) is converted into discrete droplets by forming sprays through the nozzle of an atomizer. This significantly increases the surface area of the formed discrete droplets after forming liquid bridges, and the achievable rates of evaporation of a given solvent (i.e., milling liquid forming the slurry mix of the powder blend). The atomization stage is designed to create optimum conditions for evaporation of the given solvent from the slurry mix of the formed powder blend constituted of the diamond and the amorphous boron. Nozzles and rotary atomizers are used to form sprays of the discrete droplets. Drying towers may be equipped with just one nozzle and rotary atomizer, or alternatively, with a plurality of such nozzles and rotary atomizers to form the discrete droplets.

The process 200 can generally include loading the dried powder blend constituted of the diamond and the amorphous boron into, for example, refractory metal containers in step 206. The refractory metal containers can be made of any suitable material including typically any refractory metal selected from the group consisting of tantalum, niobium, and molybdenum. However, different variations may exist, as to the particular material compartment-type that the dried powder blend may be loaded into. Alternatively, in other embodiments, the dried powder blend constituted of the diamond and the amorphous boron may be loaded into a refractory capsule constructed of hard refractory metals together with or without a cemented WC-Co or a WC disc support structure instead of being loaded into metal containers. Several of such refractory capsules may be compiled into a high-pressure cell-core. Still in other embodiments, the dried powder blend including the diamond, and the amorphous boron may be loaded into a shallow flat-bottomed cup made of a suitable hard ceramic material, such as, for example cemented WC-Co. The cup may be covered with a refractory metal disc, and thereafter used in a high-pressure high temperature (HPHT) sintering consolidation operation. In yet other embodiments, the cup may me made of a refractory metal in the likes of for examples tantalum, niobium, or molybdenum, and instead, a cemented WC-Co disc may form the covering lid.

Step 206 may include disposing the dried powder blend constituted of the diamond and the amorphous boron for example on a cemented WC-Co substrate, which is then disposed in the refractory metal containers. Alternatively, step 206 may equally include loading the dried powder blend directly into the refractory metal containers without first disposing the powder blend constituted of the diamond and the amorphous boron on a cemented WC-Co substrate, and then capping with a WC-Co disc that fits snugly within the opening of the metal containers. Moreover, step 206 can also include sealing the refractory metal containers containing the powder blend made up by the diamond and the amorphous boron and/or the WC-Co substrate disc.

Next, the process 200 may include an HPHT sintering consolidation operation in step 208 conducted in a cubic press. Sealed refractory metal containers containing the dried powder blend are placed in an HPHT-cell and HPHT sintering conditions can be applied to form the sintered B₄C-diamond composites disclosed herein. Step 208 can include sintering at internal cell pressures typically spanning from about 4 gigapascal (GPa) to about 9 GPa, from about 5 GPa to about 9 GPa, from about 5.8 GPa to about 7.4 GPa, from about 7.2 GPa to about 7.4 GPa, from about 6 GPa to about 9 GPa, from about 7 GPa to about 9 GPa, from about 8 GPa to about 9 GPa, from about 4 GPa to about 8 GPa, from about 5 GPa to about 8 GPa, from about 6 GPa to about 8 GPa, from about 7 GPa to about 8 GPa, from about 4 GPa to about 7 GPa, from about 5 GPa to about 7 GPa, from about 6 GPa to about 7 GPa, from about 4 GPa to about 5 GPa, from about 4 GPa to about 6 GPa, from about 5 GPa to about 6 GPa, at about 5.8 GPa, at about 7.2 GPa, or at about 7.4 GPa. Step 208 can typically include adopting sintering at internal cell temperatures ranging from about 1200° C. to about 2000° C., from about 1300° C. to about 2000° C., from about 1400° C. to about 2000° C., from about 1500° C. to about 2000° C., from about 1600° C. to about 2000° C., from 1700° C. to about 2000° C., from about 1800° C. to about 2000° C., from about 1900° C. to about 2000° C., from about 1200° C. to about 1900° C., from about 1300° C. to about 1900° C., from about 1400° C. to about 1900° C., from about 1500° C. to about 1900° C., from about 1600° C. to about 1900° C., from 1700° C. to about 1900° C., from about 1800° C. to about 1900° C., from about 1200° C. to about 1800° C., from about 1300° C. to about 1800° C., from about 1400° C. to about 1800° C., from about 1500° C. to about 1800° C., from about 1600° C. to about 1800° C., from 1700° C. to about 1800° C., 1200° C. to about 1700° C., from about 1300° C. to about 1700° C., from about 140° C. to about 1700° C., from about 1500° C. to about 1700° C., from about 1600° C. to about 1700° C., from about 1650° C. to about 1700° C., from 1200° C. to about 1300° C., from 1200° C. to about 1400° C., from 1200° C. to about 1500° C., from 1200° C. to about 1600° C., or from 1200° C. to about 1900° C. A dwell time may be introduced at the maximum temperature in an applied temperature range, which may typically be from 1 minute to 60 minutes, from 20 minutes to 60 minutes, from 25 minutes to 60 minutes, from 30 minutes to 60 minutes, from 35 minutes to 60 minutes, from 40 minutes to 60 minutes, from 45 minutes to 60 minutes, or from 50 minutes to 60 minutes. The temperature may typically be elevated constantly at a rate of for example about 0.70° C./min. In some examples, the temperature may be increased in tandem sequentially at a rate of about 2° C./min. switched to about 10° C./min. or for instance at a rate of about 2° C./min. changed to about 7° C./min., or for instance at a rate of about 2° C./min. changed to about 5° C./min., when a certain particular temperature in an applied temperature range has been reached. After having conducted the chosen dwell time employed at the maximum temperature in an applied temperature range, a cooling step is typically performed via conducting a step-wise temperature drop characterized by a drop rate of for example about 50° C./min. for typically about 5 minutes, or a drop rate of about 50° C./min. for about 10 minutes, or a drop rate of about 100° C./min. for about 5 minutes, or a drop rate of about 100° C./min. for about 10 minutes. Next, all heating energy may be terminated and dissipated via a rapid temperature drop by way of ideally using coolants to eventually a temperature of about 25° C., at ambient conditions.

After the HPHT sintering consolidation operation is complete in step 208, the resulting super-hard reinforced B₄C-diamond composite may next be machined to form a desired shape of the composite, like for example forming a disc of the super-hard reinforced B₄C-diamond composite. Machining may be performed by processes generally known by a skilled artisan in the appropriate art to form suitable tools. Here, machining may typically include electrical discharge machining (EDM), electrical discharge grinding (EDG), or other processes, thus forming the B₄C-diamond composite into a desired shape. For example, a skilled artisan would in practice know how EDM is performed and operated. EDM also referred to as spark machining, spark eroding, die sinking, wire burning, or wire erosion is conventionally known as a metal manufacturing process, where a desired shape is cut from a work piece by using electrical discharges.

Material is removed from the B₄C-diamond composite by a series of rapidly recurring current discharges between two electrodes, which are completely separated by a dielectric liquid, and subjected to an electric voltage treatment. One of the electrodes is called the tool electrode, or simply the “tool” or the “electrode”, while the other electrode is called the work piece electrode, or “work piece”. The process depends on the tool and the work piece not making any physical contact with one another, due to the separation of the tool and the work piece by the dielectric liquid. The dielectric liquid may be kerosene, distilled water, or an EDM oil.

When the voltage between the two electrodes is increased, the intensity of the electric field in the volume between the electrodes is also increased causing a dielectric breakdown of the liquid, and subsequently producing an electric arc. Thus, this causes a desired part of the B₄C-diamond composite to be cut and removed from the electrodes. Once the current is removed, new dielectric liquid is conveyed into the inter-electrode volume, thus enabling the solid particle B₄C-diamond debris that has been cut from the B₄C-diamond composite to be carried away, and the insulating properties of the dielectric to be restored once again. Adding new dielectric liquid in the inter-electrode volume is commonly referred to in the art of EDM as “flushing”. After a new round of increasing the current flow, the voltage between the two electrodes is once again restored to the level it was before the dielectric breakdown of the liquid, such that a new dielectric liquid breakdown can occur to repeat the foregoing cycle all over again. Typical voltage that is supplied may span a range of from about 50 volts to about 300 volts, such as from about 75 volts to about 300 volts, such as from about 100 volts to about 300 volts, such as from about 125 volts to about 300 volts, such as from about 150 volts to about 300 volts, such as from about 175 volts to about 300 volts, such as from about 200 volts to about 300 volts, such as from about 225 volts to about 300 volts, such as from about 250 volts to about 300 volts, such as from about 275 volts to about 300 volts, such as from about 50 volts to about 75 volts, such as from about 75 volts to about 100 volts, such as from about 100 volts to about 125 volts, such as from about 50 volts to about 125 volts, such as from about 75 volts to about 125 volts, such as from about 125 volts to about 150 volts, such as from about 150 volts to about 175 volts, such as from about 175 volts to about 200 volts, such as from about 125 volts to about 200 volts, such as from about 150 volts to about 200 volts, such as from about 200 volts to about 225 volts, such as from about 225 volts to about 250 volts, such as from about 250 volts to about 275 volts, such as from about 200 volts to about 275 volts, or such as from about 225 volts to about 275.

A typical shape of the super-hard reinforced B₄C-diamond composite may for example also alternatively, or in addition, include a triangle or a triangular-like shape, thus forming a tip to be used in various cutting and machining applications after brazing the formed tip onto carbide tool bodies.

The super-hard reinforced B₄C-diamond composite that is formed herein this disclosure may advantageously be used to make cutting and machining processing tools for various applications. Thus, the super-hard reinforced B₄C-diamond composite formed according to the process 200 can be used for machining difficult-to-cut individual metals, metal alloys, or ultrahigh-strength resilient superalloys. For example, in such given scenarios, the super-hard B₄C-diamond composite produced according to process 200 can be formed into cutting tools for machining of ultrahigh-strength resilient superalloys, including for example nickel-based superalloys (e.g., Inconel 718, Inconel 625), cobalt-based superalloys (e.g., Alloy 188, Haynes 25, Alloy L605), iron-based superalloys (e.g., A286), or any materials of equivalent, inferior, or superior mechanical properties than these superalloys. In other embodiments, the super-hard reinforced B₄C-diamond composite may be used to prepare interrupted cutting tooling, such as e.g., for example veined end mills, drill bits, and/or milling inserts.

Taken together, the prepared novel graphite-free and the pore-free super-hard reinforced B₄C-diamond composite disclosed herein may impart an enhanced abrasion resistance and a stellar wear resistance to cutting and machining processing tools manufactured by using such B₄C-diamond composites. This significantly improves the cutting and the machining capabilities of such prepared tools, and thus ultimately leads to valuable increased lifetimes for the produced tools.

### EXAMPLE

The following example is put forth so as to provide those of ordinary skill in the art with a complete disclosure and description of how to make and use the described subject matter and is not intended to limit the scope of what the inventors regard as their disclosure, and nor is it intended to represent that the experiment below is all, or the only experiment performed. Efforts have been made to ensure accuracy with respect to numbers used but some experimental errors and deviations should be accounted for. Unless indicated otherwise, parts are by weight, molecular weight is weight average molecular weight, temperature is in degrees Centigrade, and pressure is at or near atmospheric.

### Example 1

### Preparation of Graphite-Free and Pore-Free Super-Hard Reinforced Boron Carbide (B₄C)-Diamond Composites

A series of B₄C-diamond composite samples were prepared by dry blending a diamond powder with a D50 of 21 microns and with an amorphous boron powder in amounts of, respectively, 90 weight (wt.) % to 95 wt. % diamond powder and 5 wt. % to 10 wt. % amorphous boron powder. All samples were pressed on a cubic press by using a cell design, which is capable of ultimately producing a 16 mm diameter disc. The pressing on the cubic press was either conducted under mild high pressure high temperature (HPHT) conditions (i.e., 5.5 GPa-6.5 GPa cell pressure), or under high HPHT conditions (i.e., >7 GPa cell pressure). The internal cell temperature was varied in a temperature range spanning from about 1200° C. to about 1700° C. The foregoing pressing conditions keep the synthesis more approachable, in case, there is a need to scale up the process. External thermocouple (i.e., type C) was used to monitor the internal cell temperature.

All produced post-HPHT materials were evaluated by the following techniques. The density (3.32 g/cm³ to about 3.36 g/cm³) of the materials was measured on machined, as well as, fractured pieces by using helium pycnometry. The density was volumetrically measured on HPHT sintered samples removed from tantalum cups (i.e., used as sample containers during the HPHT operation), which were ground to cylinders. The OD of the samples was machined on a centerless grinder, and the ends were ground on an EWAG machine. OD grinders work on the external surfaces of an object, as the object is rotated between the centers. The presence of different phase compositions was detected by X-ray diffraction (XRD) spectroscopy, and single atoms were verified by performing energy-dispersive X-ray (EDS) spectroscopy. The microstructure of the materials, and their porosity were evaluated with a scanning electron microscope (SEM) on lapped, as well as, polished samples.

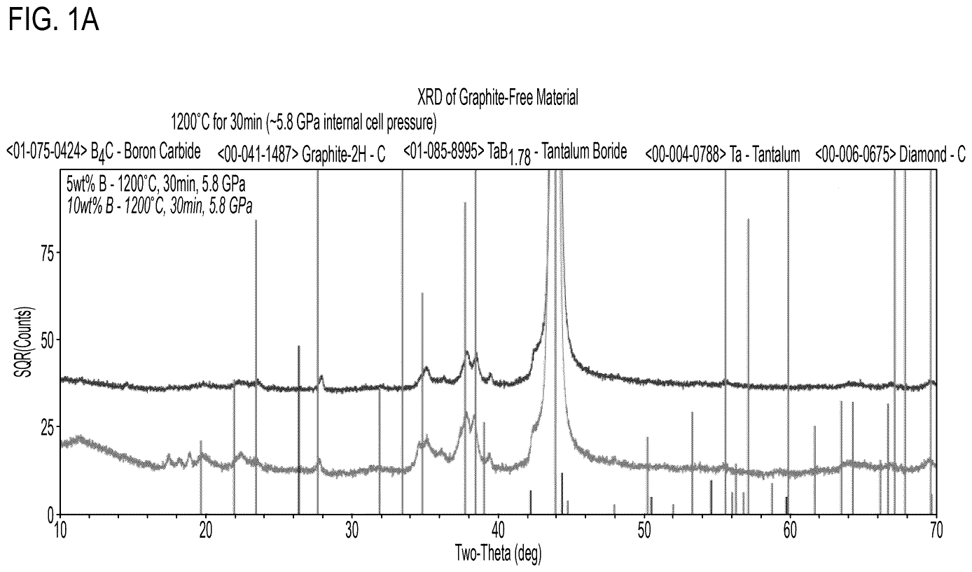

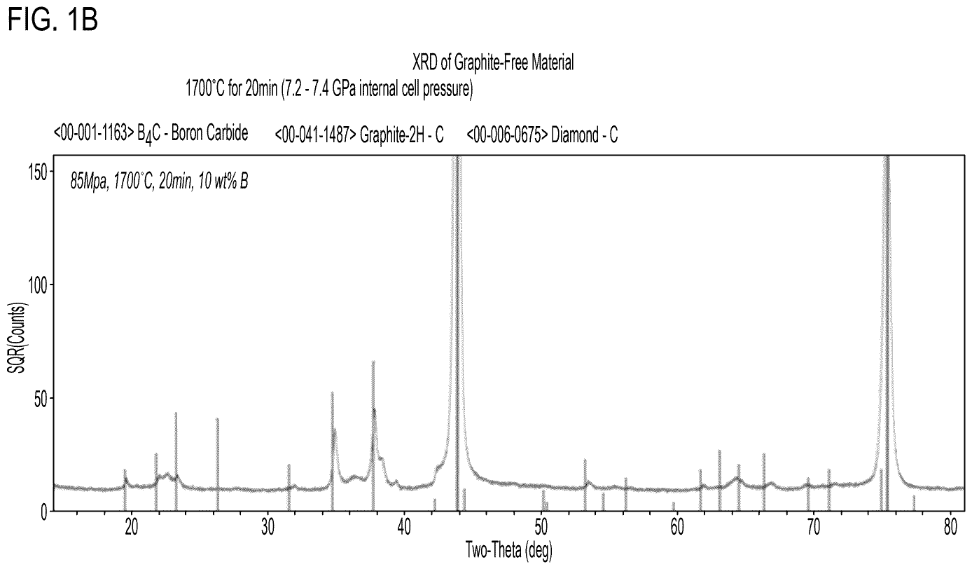

As seen in FIG. 1A, to prepare the B₄C-diamond composite, either a 5 wt. % amorphous boron powder and a 95 wt. % diamond powder were used, or a 10 wt. % amorphous boron powder and 90 wt. % diamond powder were used. Similarly, as observed in FIG. 1B, to prepare the B₄C-diamond composite, a 10 wt. % amorphous boron powder and a 90 wt. % diamond powder were used.

In FIG. 1A, it is seen that the B₄C hard phase was successfully detected as multiple vertical peaks at about 20°, 22°, 24°, 32°, 35°, 38°, 53°, 62°, 64°, 67°, 69°, and 71° two-theta degrees on the X-axis. Graphite was not present in any of the sintered B₄C-diamond composite samples. The XRD diffraction peaks at about 34°, 38°, 44°, 56°, 57°, 60°, 67°, 68°, and 70° two-theta degrees on the X-axis, that characterize tantalum (Ta) and tantalum boride (TaB_{1.78}˜TaB₂), respectively, in FIG. 1A are sweeps from the tantalum cup having therein the sintered B₄C-diamond composite samples, thus representing Ta and TaB₂ trace impurities. FIG. 1B also shows the presence of the B₄C hard phase, which was detected as multiple vertical peaks at 20°, 22°, 24°, 32°, 35°, 38°, 53°, 62°, 64°, 67°, 69°, and 71° two-theta degrees on the X-axis. Again, graphite was absent in any of the tested samples. The diamond phase was detected as the two highest vertical peaks at about 44° and 75° two-theta degrees on the X-axis as best seen in FIG. 1B

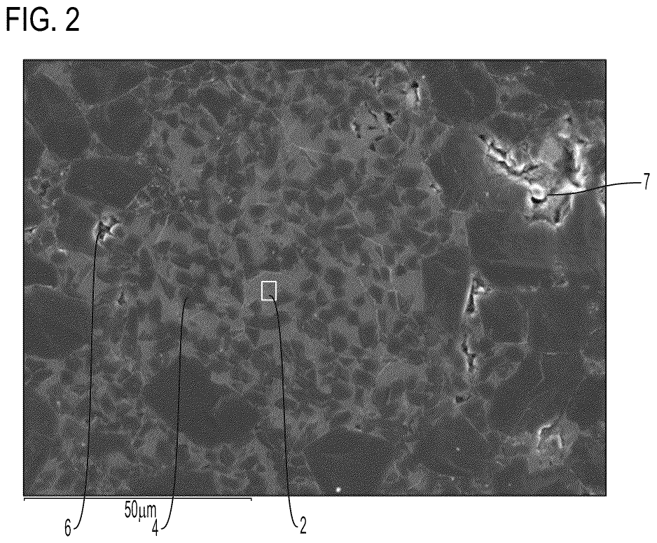

FIG. 2 shows a 1000× magnification of a scanning electron microscope (SEM) of a B₄C-diamond composite sample sintered at a temperature of 1200° C. for 30 minutes in a cubic press at a 5.8 GPa internal cell pressure in accordance with the present subject matter. To prepare the B₄C-diamond composite sample, a 10 wt. % amorphous boron powder and a 90 wt. % diamond powder were used. The non-porous matrix, which is illustrated with the numeral 2 was mainly constituted of the formed hard B₄C phase. The element reflected by 6 and 7 was predominantly unreacted elemental crystalline boron, whereas the numeral 4 reflects fine diamond crystals.

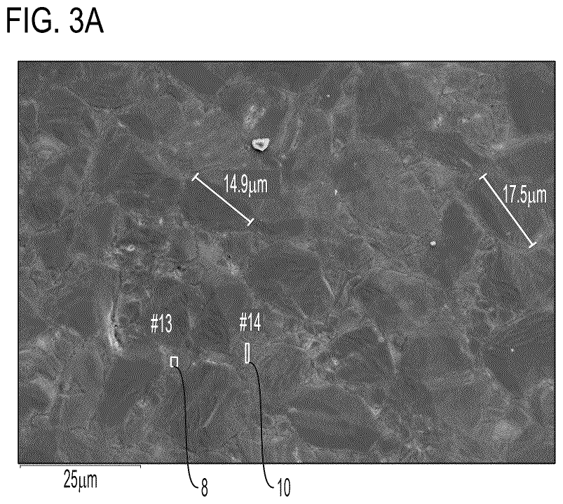

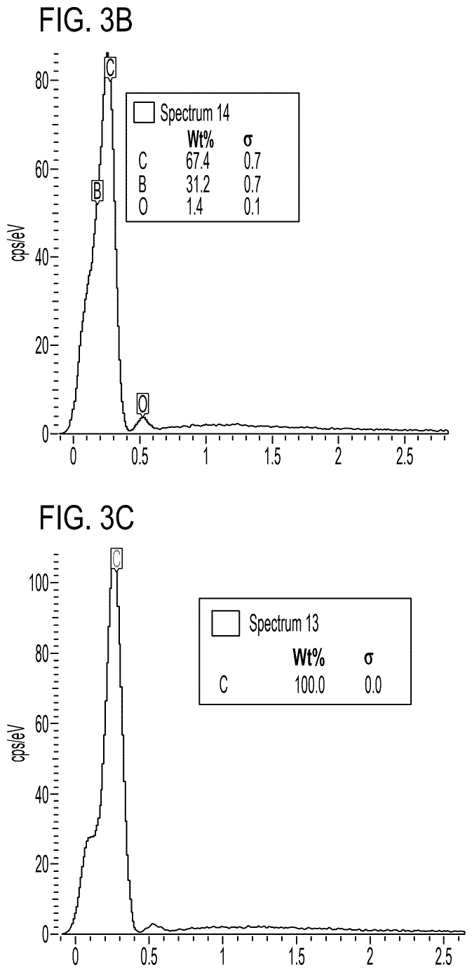

FIG. 3A shows a 1000× magnification of a SEM of a B₄C-diamond composite sample sintered at a temperature of 1700° C. for 20 minutes in a cubic press at a 7.2-7.4 GPa internal cell pressure in accordance with the present subject matter. To prepare the B₄C-diamond composite sample, a 10 wt. % amorphous boron powder and a 90 wt. % diamond powder were used. FIG. 3B shows an energy-dispersive X-ray spectroscopy (EDS) spectrum collected from region marked with #14, numeral 10 (See SEM in FIG. 3A) of the B₄C-diamond composite sample in accordance with the present subject matter. FIG. 3C shows an EDS spectrum collected from region marked with #13, numeral 8 (See SEM in FIG. 3A) of the B₄C-diamond composite sample in accordance with the present subject matter. FIG. 3B shows the presence of at least boron with a 31.2 wt. % and carbon with a 67.4 wt. % in the matrix, thus forming the B₄C illustrated with numeral 2 in FIG. 2. FIG. 3C demonstrates the presence of only carbon with a 100 wt. %. The spectrum in FIG. 3C was collected to verify that the individual fine crystals were indeed only diamond illustrated with numeral 4 in FIG. 2.

Finally, Raman spectroscopy was additionally performed, and confirmed that no graphite was present in the analyzed B₄C-diamond composite samples. Raman spectroscopy further confirmed that the diamond phase and the B₄C hard phase were the only peaks detected in the HPHT sintered samples.

Although the present disclosure has been described in connection with embodiments thereof, it will be appreciated by those skilled in the art that additions, deletions, modifications, and substitutions not specifically described may be made without departure from the spirit and scope of the disclosure as defined in the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The illustrative embodiments described in the detailed description, drawings, and claims are not meant to be limiting. Other embodiments may be utilized, and other changes may be made, without departing from the spirit or scope of the subject matter presented here.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges which can independently be included in the smaller ranges is also encompassed within the disclosure, subject to any specifically excluded limit in the stated range. Where the stated range includes one or both of the limits, ranges excluding either both of those included limits are also included in the disclosure.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Additionally, for example any sequence(s) and/or temporal order of sequence of the system and method that are described herein this disclosure are illustrative and should not be interpreted as being restrictive in nature. Accordingly, it should be understood that the process steps may be shown and described as being in a sequence or temporal order, but they are not necessarily limited to being carried out in any particular sequence or order. For example, the steps in such processes or methods generally may be carried out in various different sequences and orders, while still falling within the scope of the present disclosure.

Finally, the discussed application publications and/or patents herein are provided solely for their disclosure prior to the filing date of the described disclosure. Nothing herein should be construed as an admission that the described disclosure is not entitled to antedate such publication by virtue of prior disclosure.

1. A super-hard boron carbide (B₄C)-diamond composite, comprising:
diamond particles present in a weight of from about 91 weight percent (wt. %) to about 95 wt. % based on a total weight of the composite; and
B₄C particles present in a weight of from about 5 wt. % to about 9 wt. % based on a total weight of the composite,
wherein the B₄C-diamond composite is graphite-free and pore-free.

2. The B₄C-diamond composite of claim 1, wherein the diamond particles comprise a diamond material selected from the group consisting of monocrystalline diamond, and polycrystalline diamond, and the diamond particles have a D50 particle size in a range of from about 21 microns to about 50 microns.

3. The B₄C-diamond composite of claim 1, wherein the B₄C-diamond composite has a density in a range of from about 3.32 g/cm³ to about 3.36 g/cm³.

4. A method of forming a super-hard boron carbide (B₄C)-diamond composite, comprising:
preparing a batch of powdered materials comprising a diamond powder in a weight of from about 91 weight percent (wt. %) to about 95 wt. % based on a total weight of the batch of powdered materials and an amorphous boron powder in a weight of from about 5 wt. % to about 9 wt. % based on a total weight of the batch of powdered materials;
mixing the batch of powdered materials to form a powder blend;
drying the powder blend;
loading the powder blend into one or more refractory metal containers; and
sintering the powder blend at high pressure high temperature (HPHT) conditions to form the super-hard B₄C-diamond composite,
wherein the B₄C-diamond composite is graphite-free and pore-free.

5. The method of forming a super-hard B₄C-diamond composite of claim 4, wherein the HPHT conditions to form the super-hard B₄C-diamond composite comprise using an internal cell pressure in a range of from about 5 GPa to about 9 GPa.

6. The method of forming a super-hard B₄C-diamond composite of claim 5, wherein the HPHT conditions to form the super-hard B₄C-diamond composite comprise using an internal cell pressure in a range of from about 5.8 GPa to about 7.4 GPa.

7. The method of forming a super-hard B₄C-diamond composite of claim 6, wherein the HPHT conditions to form the super-hard B₄C-diamond composite comprise using an internal cell pressure in a range of from about 5.8 GPa to about 7.2 GPa.

8. The method of forming a super-hard B₄C-diamond composite of claim 6, wherein the HPHT conditions to form the super-hard B₄C-diamond composite comprise using an internal cell pressure in a range of from about 7.2 GPa to about 7.4 GPa.

9. The method of forming a super-hard B₄C-diamond composite of claim 6, wherein the HPHT conditions to form the super-hard B₄C-diamond composite comprise using an internal cell pressure of about 5.8 GPa.

10. The method of forming a super-hard B₄C-diamond composite of claim 7, wherein the HPHT conditions to form the super-hard B₄C-diamond composite comprise using an internal cell pressure of about 7.2 GPa.

11. The method of forming a super-hard B₄C-diamond composite of claim 6, wherein the HPHT conditions to form the super-hard B₄C-diamond composite comprise using an internal cell pressure of about 7.4 GPa.

12. The method of forming a super-hard B₄C-diamond composite of claim 4, wherein the HPHT conditions to form the super-hard B₄C-diamond composite comprise using an internal cell temperature in a range of from about 1200° C. to about 1700° C.

13. The method of forming a super-hard B₄C-diamond composite of claim 4, wherein the sintering is a solid-state sintering.

14. The method of forming a super-hard B₄C-diamond composite of claim 4, wherein the drying the powder blend comprises vacuum drying, air drying, freeze drying, furnace drying or spray drying.

15. The method of forming a super-hard B₄C-diamond composite of claim 4, wherein the mixing the batch of powdered materials is performed with one or more solvents comprising ethanol, methanol, isopropanol, butanol, cyclohexanol, acetone, hexane, heptane, toluene, water, or any combination thereof as a slurry mix of the powder blend.

16. The method of forming a super-hard B₄C-diamond composite of claim 4, wherein the powder blend is loaded into one or more refractory cups.

17. The method of forming a super-hard B₄C-diamond composite of claim 16, wherein the B₄C-diamond composite comprises trace impurities swept from the one or more refractory cups.

18. The method of forming a super-hard B₄C-diamond composite of claim 17, wherein the trace impurities comprise at least one or more of tantalum (Ta), niobium (Nb), or tantalum boride (TaB₂).

19. A cutting tool, comprising the super-hard B₄C-diamond composite of claim 1.
